(19) United States
(12) Patent Application Publication
(10) Pub. No.: US 2015/0046637 A1
(43) Pub. Date: Feb. 12, 2015

(54) DATA STORAGE DEVICE AND METHOD FOR RESTRICTING ACCESS THEREOF

(71) Applicant: Silicon Motion, Inc., Jhubei City (TW)

(72) Inventors: Jieh-Hsin CHIEN, Taoyuan City (TW); Yi-Hua PAO, Hsinchu City (TW)

(21) Appl. No.: 14/450,932

(22) Filed: Aug. 4, 2014

Related U.S. Application Data
(60) Provisional application No. 61/862,872, filed on Aug. 6, 2013.

(30) Foreign Application Priority Data
Dec. 20, 2013 (TW) 102147385

(51) Int. Cl. G06F 3/06

(52) U.S. Cl. CPC G06F 3/0622; G06F 3/0679; G06F 3/0634
USPC 711/103

(57) ABSTRACT

A data storage device including a flash memory, a temperature sensor and a controller. The flash device is arranged to store data. The temperature sensor is arranged to detect surrounding ambient temperature. The controller is configured to receive a write command from a host, and perform a protection mechanism when the detected surrounding ambient temperature is outside a predetermined rage, wherein the write command is arranged to enable the controller to write data into the flash, and the controller is configured to restrict writing during the protect mode.

### CROSS REFERENCE TO RELATED APPLICATIONS

This Application claims priority to Taiwan Patent Application No. 102147385, filed on Dec. 20, 2013, the entirety of which is incorporated by reference herein. Furthermore, this application is a non-provisional of U.S. Provisional Application No. 61/862,872 filed on Aug. 6, 2013.

### BACKGROUND OF THE INVENTION

1. Field of the Invention

The present invention relates to an access prohibition method applied to a memory device, and in particular to an access prohibition method in response to the temperature.

2. Description of the Related Art

Flash memory is considered a non-volatile data storage device, using electrical methods to erase and program itself Taking NAND Flash as an example, it is often used in memory cards, USB flash devices, solid state devices, eMMC and other uses.

Flash memory such as NAND Flash uses a multiple-block structure to store data, wherein the flash memory is constructed by floating gate transistors. The floating gates of the floating gate transistor may catch electronic charges for storing data. However, the floating gates may lose the electronic charges due to various operations and the various environmental parameters of the flash memory, which can lead to read and write errors.

### BRIEF SUMMARY OF THE INVENTION

A detailed description is given in the following embodiments with reference to the accompanying drawings.

The present invention provides a data storage device. The data storage device includes a flash memory, a temperature sensor, and a controller. The flash memory is arranged to store data. The temperature sensor is arranged to detect the surrounding ambient temperature. The controller is configured to receive write commands from a host device for enabling the controller to write data to the flash memory, and perform a protection mechanism when the detected surrounding ambient temperature is outside a predetermined range, wherein the protection mechanism of the controller is configured to disable all of the write commands received from the host device.

The present invention further provides an access prohibition method applied to a data storage device having a flash memory. The access prohibition method includes: reading a temperature sensor to obtain temperature parameters of current surrounding ambient temperature at a predetermined time interval; and enabling a protection mechanism for disabling write commands received from a host device when the surrounding ambient temperature is outside a predetermined range, wherein the write commands are arranged to write data into the flash memory.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an embodiment of an electronic system of the present invention; and

FIG. 2 is a flowchart of an access prohibition method according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

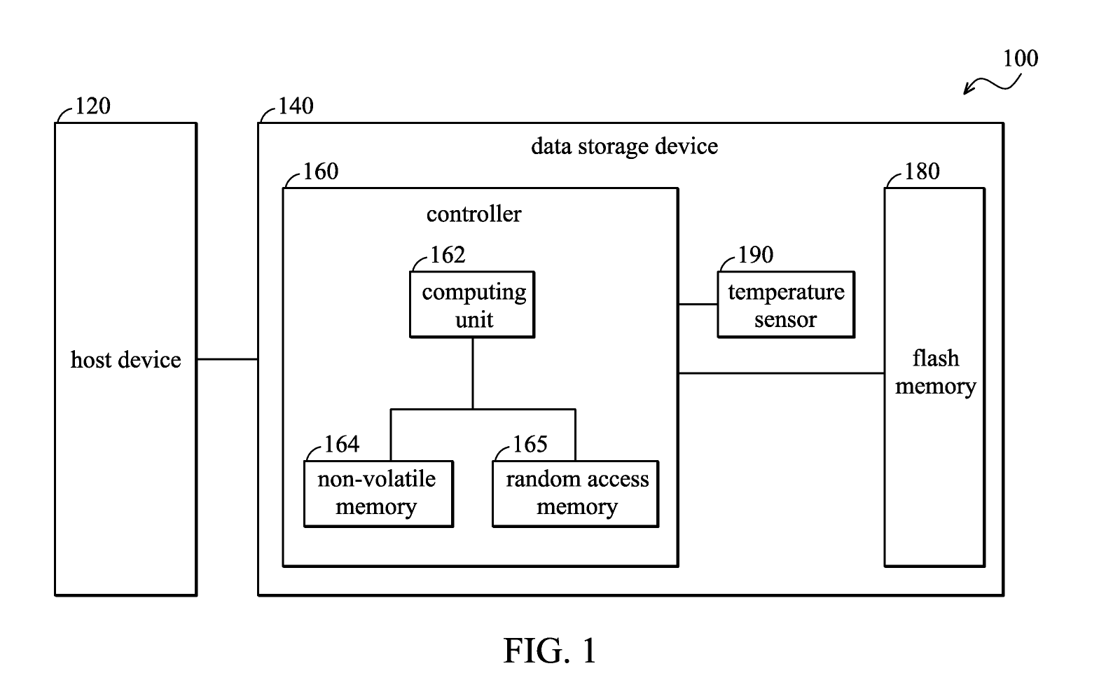

FIG. 1 is a schematic diagram illustrating an embodiment of an electronic system of the present invention. The electronic system 100 includes a host device 120 and a data storage device 140. The data storage device 140 includes a controller 160, a flash memory 180 and a temperature sensor 190. Furthermore, the data storage device 140 is arranged to operate in response to the commands of the host device 120. The controller 160 further includes a computing unit 162, a non-volatile memory 164 (such as read only memory ROM) and a random access memory 165. The program code and data stored in the nonvolatile memory 164 may constitute firmware, and may be performed by the computing unit 162, such that the controller 160 may control the flash memory 180 by the firmware. For example, the controller 160 may access the flash memory 180 according to the commands received from the host device 120 and automatically perform the access prohibition method of the present invention. The flash memory 180 has a plurality of blocks, and each of the blocks has a plurality of pages. It should be noted that, in other embodiments, the controller 160 may further include a timing device (not shown), but it is not limited thereto. For example, the controller 160 is configured to count time according to the clock signal received from other devices or the clock signal produced by the controller 160 itself The temperature sensor 190 is arranged to detect the surrounding ambient temperature of the data storage device 140, and produce temperature parameters in response to the variation of the surrounding ambient temperature. In this embodiment, the temperature sensor 190 is implemented next to the flash memory 180 of the data storage device 140 and arranged to detect the surrounding ambient temperature of the flash memory 180, but it is not limited thereto. In another embodiment, the temperature sensor 190 may be implemented outside of the data storage device 140 and arranged to detect the surrounding ambient temperature of the data storage device 140.

Moreover, the flash memory 180 is further arranged to store the parameters corresponding to a predetermined range of temperature. In other embodiments, the flash memory 180 further includes the parameters corresponding to a plurality of ranges of temperature, wherein the controller 160 is further configured to select one of the predetermined ranges according to a key or an identifier, and use the selected predetermined range as the predetermined range of the access prohibition method. In one embodiment, the predetermined range is from −40 degrees Celsius to 85 degrees Celsius, but it is not limited thereto. Persons with skill in the art may determine the predetermined ranges according to the read and write error rates of the flash memory at different temperatures. It should be noted that, in one embodiment, different vendors and clients may have different keys and identifiers.

In one embodiment, the controller 160 may enable a protection mechanism according to the surrounding ambient temperature to disable the host device 120 to read or write the flash memory 180. For example, the controller 160 is configured to receive the read commands and the write commands from the host device 120, and perform (enable) the protection mechanism when the surrounding ambient temperature is outside a predetermined range, wherein the read command is further arranged to enable the controller 160 to retrieve the data from the flash memory 180, and the write command is arranged to enable the controller 160 to write data into the flash memory 180. In the protection mechanism, the controller 160 disables or ignores all of the write commands received from the host device 120, but it is not limited thereto. In another embodiment, in the protection mechanism, the controller 160 is further configured to disable or ignore all of the read commands received from the host device 120. In one embodiment, the controller 160 is further configured to produce a warning signal when the surrounding ambient temperature is outside the predetermined range, and transmit the warning signal to the host device 120 as an alert about the prohibition of the read commands and write commands (reading and writing), but it is not limited thereto. In another embodiment, the controller 160 produces a warning signal when the controller 160 receives a write command or a read command and the protection mechanism has been enabled, and transmits the warning signal to the host device 120 for noticing the host device that the read and write operations of the flash memory 180 is prohibited. For example, the controller 160 may enable the Write Protect Mode (Pull WP) to disable data-writing into or data-reading from the flash memory 180 when the surrounding ambient temperature is outside the predetermined range. Namely, the protection mechanism of the controller 160 may set the Write Protect Pin (Pull WP) to disable data-writing into or data-reading from the flash memory 180 when the surrounding ambient temperature is outside the predetermined range. Moreover, the controller 160 may be further arranged to ignore the read command received from the host device when the surrounding ambient temperature is outside the predetermined range. Namely, the protection mechanism performed by the controller 160 may be further arranged to ignore the read command received from the host device in the protection mechanism. In another embodiment, the controller 160 may enable a protection mechanism according to the surrounding ambient temperature, and the controller 160 sets the connection interface (such as a SATA interface) coupled with the host device 120 for disabling write commands to be transmitted to the flash memory 180. Namely, the host device 120 cannot transmit the write command to the controller 160 when the surrounding ambient temperature is outside the predetermined range (−45 degrees Celsius ˜85 degrees Celsius), because the Write Protect Pin is set. Therefore, the host device 120 cannot write data into the data storage device 140.

Moreover, in other embodiments, the predetermined range for the write temperature can be different from the predetermined range for the read temperature. For example, in one embodiment, the protection mechanism may include a read protection mechanism and a write protection mechanism, and the predetermined range of the read protection mechanism may be different from the predetermined range of the write protection mechanism. Namely, the read protection mechanism and the write protection mechanism can be enabled in response to the different surrounding ambient temperatures at different times. The read protection mechanism is arranged to disable the host device 120 to read the flash memory 180. The write protection mechanism is arranged to disable the host device 120 to write data into the flash memory 180.

More specifically, the controller 160 is configured to read the temperature sensor 190 to obtain the temperature parameter of the current surrounding ambient temperature at a predetermined time interval. Furthermore, the controller 160 is further configured to determine whether the temperature parameter of the current surrounding ambient temperature is outside the predetermined range, and enable the protection mechanism when the temperature parameter of the current surrounding ambient temperature is outside the predetermined range. In the embodiment within the read protection mechanism and the write protection mechanism, the controller 160 is further configured to read the temperature sensor 190 to obtain the temperature parameter of the current surrounding ambient temperature at a predetermined time interval, and determine whether the temperature parameter of the current surrounding ambient temperature is outside the predetermined range corresponding to the read protection mechanism and/or the predetermined range corresponding to the write protection mechanism. The controller 160 enables the write protection mechanism and/or the read protection mechanism when the temperature parameter of the current surrounding ambient temperature is outside the predetermined range corresponding to the read protection mechanism and/or the predetermined range corresponding to the write protection mechanism. Moreover, in the protection mechanism, the controller 160 continues to read the temperature sensor 190 to obtain the temperature parameter of the current surrounding ambient temperature at the predetermined time interval, determine whether the temperature parameter of the current surrounding ambient temperature is outside the predetermined range, and turn off the protection mechanism when the temperature parameter of the surrounding ambient temperature is in the predetermined range.

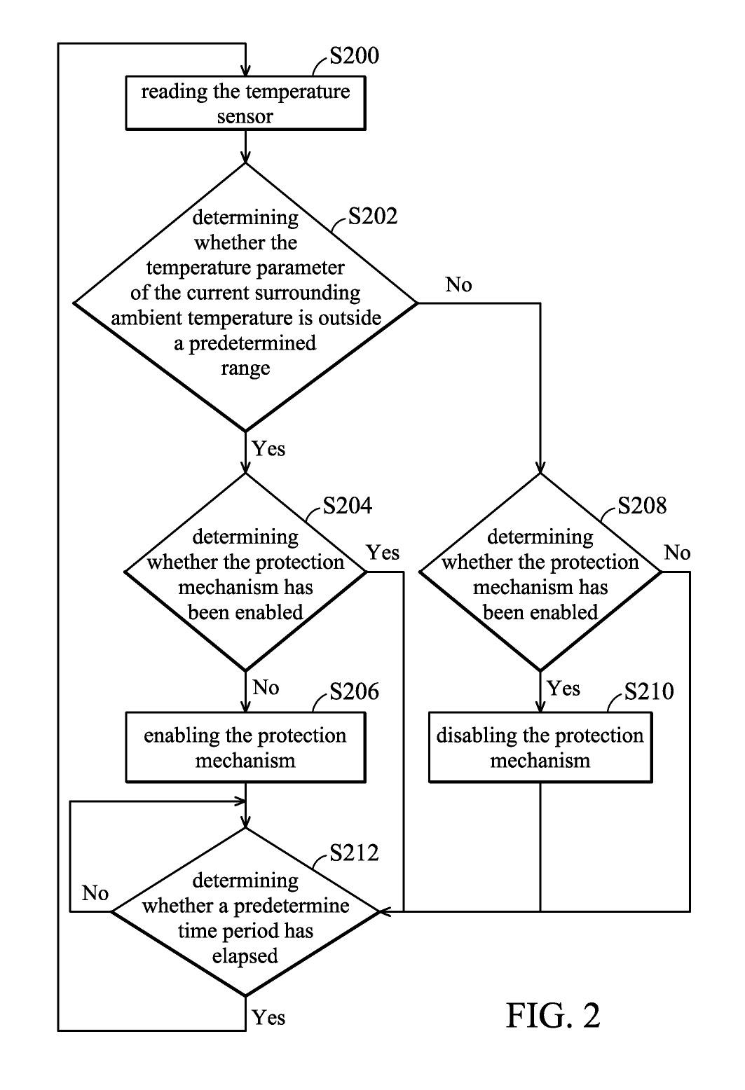

FIG. 2 is a flowchart of an access prohibition method according to an embodiment of the present invention. The access prohibition method is applied to the data storage device 140 of FIG. 1. The process starts at step S200.

In step S200, the controller 160 reads the temperature sensor 190 to obtain the temperature parameter of the current surrounding ambient temperature.

Next, in step S202, the controller 160 determines whether the temperature parameter of the current surrounding ambient temperature is outside a predetermined range. When the temperature parameter is outside the predetermined range, the process goes to step S204. When the temperature parameter is not outside the predetermined range, the process goes to step S208. In one embodiment, the predetermined range is from −40 degrees Celsius to 85 degrees Celsius, but it is not limited thereto. The skill in the art may determine the predetermined ranges according to the read and write error rates of the flash memory in different temperatures.

Next, in step S204, the controller 160 determines whether the protection mechanism has been enabled. When the protection mechanism has been enabled, the process goes to step S208. When the protection mechanism has not been enabled, the process goes to step S206.

Next, in step S206, the controller 160 turns on the protection mechanism to disable all of the write commands received from the host device 120, which is arranged to write data into the flash memory 180. It should be noted that, in the protection mechanism of another embodiment, the controller 160 is further configured to disable all of the read commands received from the host device 120 which is arranged to retrieve data from the flash memory 180 when the temperature parameter of the current surrounding ambient temperature is outside the predetermined range. In one embodiment, the controller 160 is further configured to produce a warning signal when the temperature parameter of the current surrounding ambient temperature is outside the predetermined range, and transmit the warning signal to the host device 120 as notification of the prohibition of the read commands and write commands, but it is not limited thereto. In another embodiment, the controller 160 produces a warning signal when the controller 160 receives a write command or a read command in the protection mechanism has been enabled, and transmits the warning signal to the host device 120 for noticing the host device that the read and write operations of the flash memory 180 is prohibited. The controller 106 produces a warning signal when the controller 160 receives a write command or read command in the protection mechanism, and transmits the warning signal to the host device 120 to notice the host device 120 to disable the flash memory 180 to be accessed. For example, the controller 160 may enable the Write Protect Mode (Pull WP) to disable data-writing into or data-reading from the flash memory 180 when the surrounding ambient temperature is outside the predetermined range. Namely, the protection mechanism of the controller 160 may set the Write Protect Pin (Pull WP) to disable data-writing into or data-reading from the flash memory 180 when the surrounding ambient temperature is outside the predetermined range. Moreover, the controller 160 may further arranged to ignore the read command received from the host device when the surrounding ambient temperature is outside the predetermined range. Namely, the protection mechanism performed by the controller 160 may further arranged to ignore the read command received from the host device in the protection mechanism. In another embodiment, the controller 160 may enable a protection mechanism according to the surrounding ambient temperature, and the controller 160 sets the connection interface (such as SATA interface) coupled with the host device 120 for disabling write commands to be transmitted to the flash memory 180. Namely, the host device 120 cannot transmit the write command to the controller 160 when the surrounding ambient temperature is outside the predetermined range (−45 degrees Celsius ˜85 degrees Celsius), because the Write Protect Pin is set. Therefore, the host device 120 cannot write data into the data storage device 140.

In step S208, the controller 160 determines whether the protection mechanism has been enabled. When the protection mechanism is enabled, the process goes to step S210. When the protection mechanism is not enabled, the process goes to step S212.

In step S210, the controller 160 disables the protection mechanism.

Next, in step S212, the controller 160 determines whether a predetermined time period has elapsed. When the predetermined time period has elapsed, the process goes to step S200, and the controller 160 continues to read the temperature sensor 19 to obtain the temperature parameter of the current surrounding ambient temperature. When the predetermined time period has not elapsed, the controller 160 continues to determine whether the predetermined time period has elapsed.

It will be seen from the above that the data storage device 140 and the access prohibition method may restrict the host device 120 to access the flash memory according to the surrounding ambient temperature.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data storage device, comprising:
a flash memory, arranged to store data;
a temperature sensor, arranged to detect surrounding ambient temperature; and
a controller, arranged to receive write commands from a host device for enabling the controller to write data to the flash memory, and perform a protection mechanism when the detected surrounding ambient temperature is outside a predetermined range, wherein the protection mechanism of the controller is configured to disable all of the write commands received from the host device.

2. The data storage device as claimed in claim 1, wherein the controller is configured to receive read commands from the host device for enabling the controller to retrieve data from the flash memory, wherein the protection mechanism is further arranged to disable all of the read commands received from the host device.

3. The data storage device as claimed in claim 1, wherein the controller is further configured to produce a warning signal and transmit the warning signal to the host device as notification of the prohibition of reading and writing when the surrounding ambient temperature is outside the predetermined range.

4. The data storage device as claimed in claim 1, wherein the controller is further configured to read the temperature sensor to obtain temperature parameters of the surrounding ambient temperature at a predetermined time interval.

5. The data storage device as claimed in claim 4, wherein the controller is further configured to enable the protection mechanism when the current temperature parameter is outside the predetermined range, and disable the protection mechanism when the obtained temperature parameter is within the predetermined range.

6. The data storage device as claimed in claim 1, wherein the predetermined range is from −40 degrees Celsius to 85 degrees Celsius.

7. An access prohibition method, applied to a data storage device having a flash memory, comprising:
reading a temperature sensor to obtain temperature parameters of current surrounding ambient temperature at a predetermined time interval; and
enabling a protection mechanism for disabling write commands received from a host device when the surrounding ambient temperature is outside a predetermined range, wherein the write commands are arranged to write data into the flash memory.

8. The access prohibition method as claimed in claim 7, further comprising disabling read commands received from the host device by the protection mechanism, wherein the read commands are arranged to retrieve data from the flash memory.

9. The access prohibition method as claimed in claim 7, further comprising:
producing a warning signal when the obtained temperature parameter is outside the predetermined range; and
transmitting the warning signal to the host device as notification of the prohibition of reading and writing.

10. The access prohibition method as claimed in claim 7, further comprising disabling the protection mechanism when the obtained temperature parameter is in the predetermined range.

11. The access prohibition method as claimed in claim 7, wherein the predetermined range is from −40 degrees Celsius to 85 degrees Celsius.

12. A data storage device, comprising:
a flash memory, arranged to store data;
a controller, is arranged to enable a protection mechanism for disabling a host device to transmit a write command when the detected surrounding ambient temperature is outside a predetermined range.

13. The data storage device as claimed in claim 12, wherein the protection mechanism is enabled by setting a Write Protect Pin by the controller.
